(19) United States
(12) Patent Application Publication
(10) Pub. No.: US 2025/0245732 A1
(43) Pub. Date: Jul. 31, 2025

(54) POSE CORRECTION FOR ENABLING VIRTUAL-TRY-ON

(71) Applicant: Walmart Apollo, LLC, Bentonville, AR (US)

(72) Inventor: Ohad Shaubi, Yavne (IL)

(73) Assignee: Walmart Apollo, LLC, Bentonville, AR (US)

(21) Appl. No.: 19/040,570

(22) Filed: Jan. 29, 2025

Related U.S. Application Data
(60) Provisional application No. 63/626,662, filed on Jan. 30, 2024.

(51) Int. Cl. G06Q 30/0601; G06T 7/11; G06T 7/33; G06T 11/40; G06V 10/44

(52) U.S. Cl. CPC G06Q 30/0643; G06T 7/11; G06T 7/344; G06T 11/40; G06V 10/44

(57) ABSTRACT

A method can include: obtaining a non-frontal image of an item of clothing from a catalog as a candidate for being transformed into a frontal image; extracting, using multiple deep-learning blocks, pixel data of a cloth point of interest of the non-frontal image; re-aligning, using a generative pose transfer model, the non-frontal image by altering an angle alignment of a non-frontal pose and filling in missing areas with simulated cloth matching the cloth point of interest into the frontal image; and tuning, using a cloth feature loss function, multiple parameters of the frontal image for a final version of the frontal image. Other embodiments are disclosed.

### CROSS-REFERENCE TO RELATED APPLICATIONS

This application claims priority to U.S. Provisional Application No. 63/626,662 filed on Jan. 30, 2024, which is incorporated by reference herein in its entirety for all purposes.

### FIELD OF THE DISCLOSURE

The present disclosure generally relates to using virtual reality to try on clothes and other items.

### BACKGROUND

More and more products, including clothes, are sold on-line each year. However, a customer viewing a shirt on-line does not have the same experience as trying on the shirt in a store to see how the shirt looks on the customer. Accordingly, a need exists for systems and methods for trying on clothes and other items when shopping on-line.

### BRIEF DESCRIPTION OF THE DRAWINGS

To facilitate further description of the embodiments, the following drawings are provided in which:

FIG. 1 illustrates a front elevation view of one or more computer systems, according to one embodiment, that are suitable for implementing at least a portion of an embodiment of the system disclosed in FIG. 3;

FIG. 2 illustrates a representative block diagram of an example of elements included in circuit boards inside the chassis of the computer system of FIG. 1;

FIG. 3 illustrates a block diagram for a virtual reality system for transforming a non-frontal image into a frontal image, according to one embodiment;

FIG. 4 illustrates a flow chart for transforming a non-frontal image into a frontal image, according to an embodiment;

FIG. 5 illustrates another flow chart, according to an embodiment;

FIG. 6 illustrates stock images, according to an embodiment;

FIG. 7 illustrates use of skeleton diagrams as references for a non-frontal image, according to an embodiment; and

FIG. 8 illustrates non-frontal images transformed into frontal images, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

In some embodiments, a system can include a processor and a non-transitory computer-readable medium storing computing instructions, that when executed on the processor, cause the processor to perform operations. The operations can include obtaining a non-frontal image of an item of clothing from a catalog as a candidate for being transformed into a frontal image; extracting, using multiple deep-learning blocks, pixel data of a cloth point of interest of the non-frontal image; re-aligning, using a generative pose transfer model, the non-frontal image by altering an angle alignment of a non-frontal pose and filling in missing areas with simulated cloth matching the cloth point of interest into the frontal image; and tuning, using a cloth feature loss function, multiple parameters of the frontal image for a final version of the frontal image.

In other embodiments, a method can be implemented via execution of computing instructions configured to run on a processor and be stored at a non-transitory computer-readable medium. The method can include obtaining a non-frontal image of an item of clothing from a catalog as a candidate for being transformed into a frontal image; extracting, using multiple deep-learning blocks, pixel data of a cloth point of interest of the non-frontal image; re-aligning, using a generative pose transfer model, the non-frontal image by altering an angle alignment of a non-frontal pose and filling in missing areas with simulated cloth matching the cloth point of interest into the frontal image; and tuning, using a cloth feature loss function, multiple parameters of the frontal image for a final version of the frontal image.

In further embodiments, a non-transitory computer readable storage medium can store computing instructions. When run on a processor, the computing instructions can cause the processor to perform operations. The operations can include obtaining a non-frontal image of an item of clothing from a catalog as a candidate for being transformed into a frontal image; extracting, using multiple deep-learning blocks, pixel data of a cloth point of interest of the non-frontal image; re-aligning, using a generative pose transfer model, the non-frontal image by altering an angle alignment of a non-frontal pose and filling in missing areas with simulated cloth matching the cloth point of interest into the frontal image; and tuning, using a cloth feature loss function, multiple parameters of the frontal image for a final version of the frontal image.

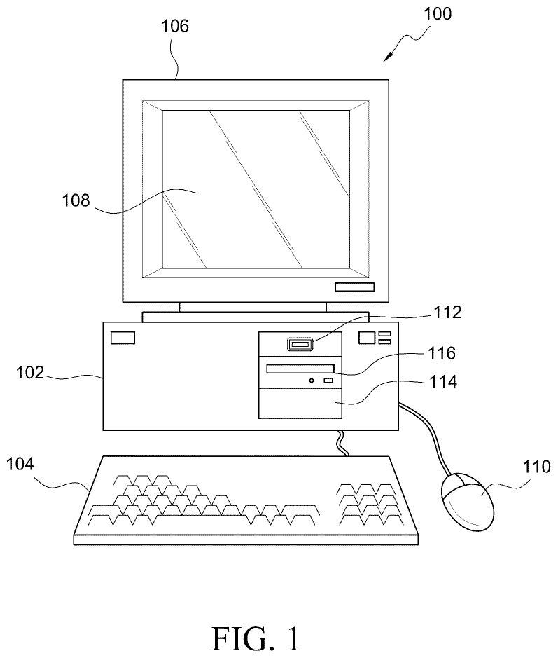

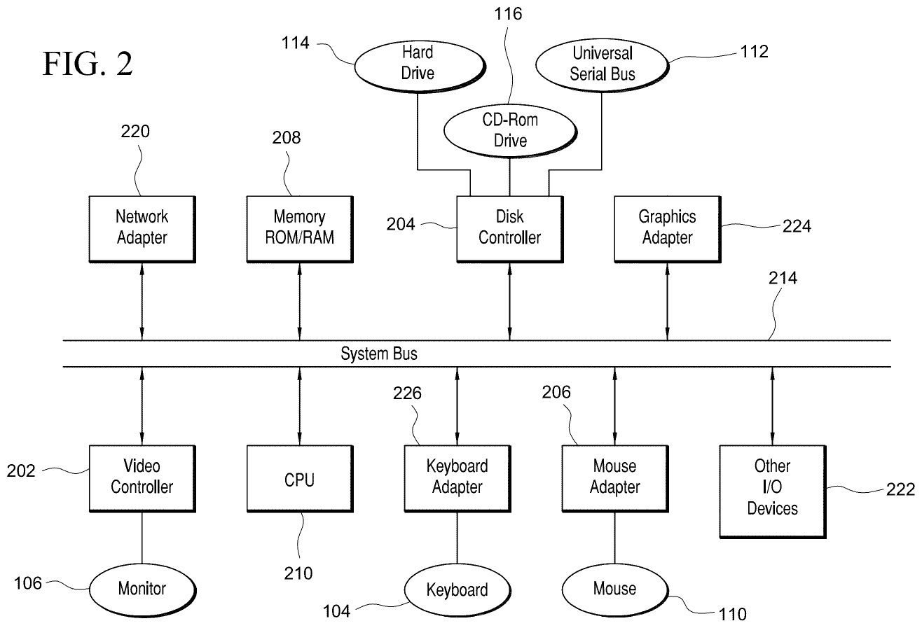

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. As another example, one or more of the programs and/or executable program components described herein can be implemented in one or more ASICs. In many embodiments, an ASIC can include one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

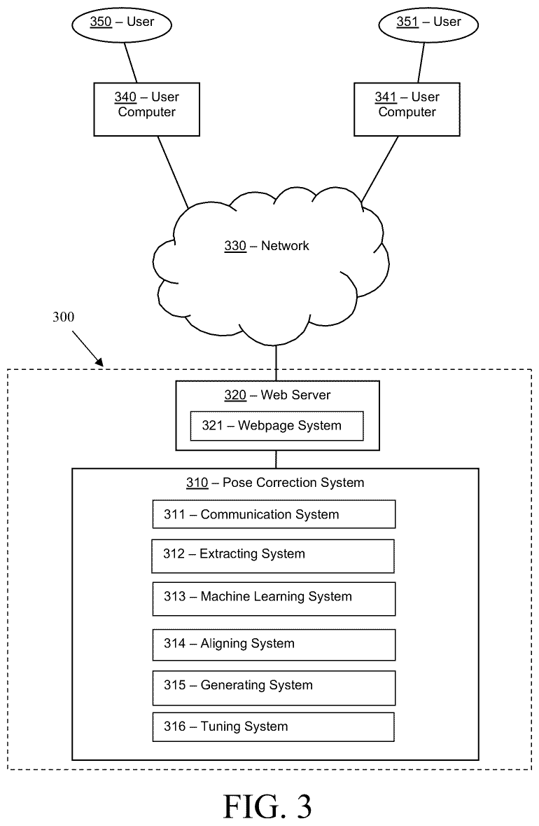

Turning ahead in the drawings, FIG. 3 illustrates a block diagram of a system 300 for transforming a non-frontal pose of an image to a frontal pose, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a pose correction system 310 and/or a web server 320. Pose correction system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, pose correction system 310 and/or web server 320. Additional details regarding pose correction system 310 and/or web server 320 are described herein.

In a number of embodiments, each system of pose correction system 310 and/or web server 320 can be a special-purpose computer programed specifically to perform specific functions not associated with a general-purpose computer, as described in greater detail below.

In some embodiments, web server 320 can be in data communication through a network 330 with one or more user computers, such as user computers 340 and/or 341. Network 330 can be a public network, a private network, or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allow users to browse and/or search for items (e.g., products), to view items in a virtual space and/or environment, such as virtual-try-on (VTON), to add items to an electronic shopping cart, and/or to order (e.g., purchase) items, in addition to other suitable activities.

In some embodiments, an internal network that is not open to the public can be used for communications between pose correction system 310 and/or web server 320 within system 300. Accordingly, in some embodiments, pose correction system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can include the Virtual Retinal Display™ product, or similar product by the University of Washington of Seattle, Washington, United States of America. Meanwhile, in further specific examples, a limb mountable wearable user computer device can include the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In several embodiments, system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300. In a similar manner, the processors and/or the non-transitory computer-readable media can be local and/or remote to each other.

Meanwhile, in many embodiments, system 300 also can be configured to communicate with and/or include one or more databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between system 300, network 330, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, pose correction system 310 can include a communication system 311, an extracting system 312, a machine learning system 313, an aligning system 314, a generating system 315, and/or a tuning system 316. In many embodiments, the systems of pose correction system 310 can be modules of computing instructions (e.g., software modules) stored at non-transitory computer readable media that operate on one or more processors. In other embodiments, the systems of pose correction system 310 can be implemented in hardware. Pose correction system 310 can be a computer system, such as computer system 100 (FIG. 1), as described above, and can be a single computer, a single server, or a cluster or collection of computers or servers, or a cloud of computers or servers. In another embodiment, a single computer system can host pose correction system 310. Additional details regarding pose correction system 310 and the components thereof are described herein.

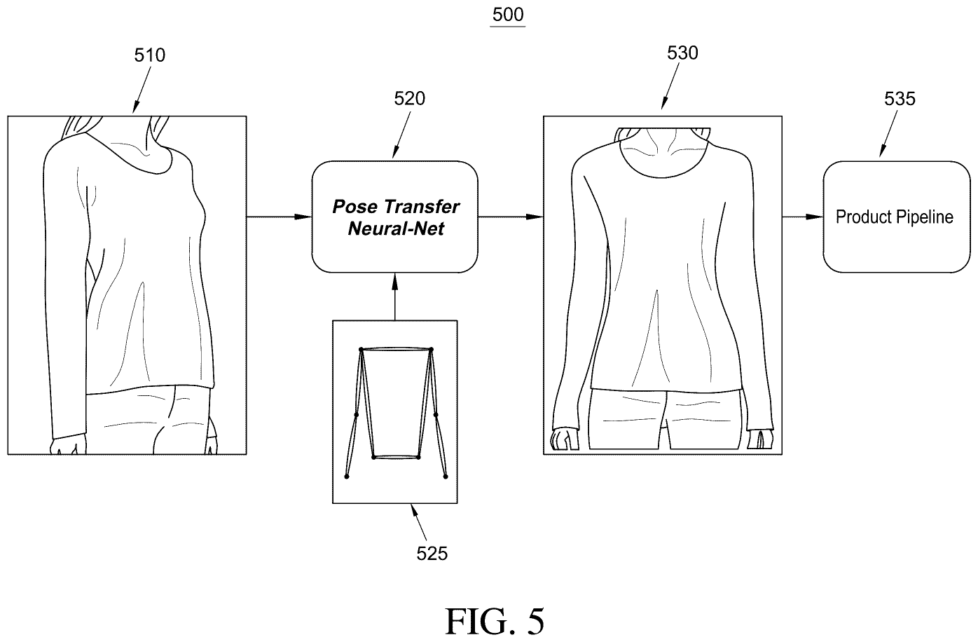

Jumping ahead in the drawings, FIG. 5 illustrates a flow chart for method 500 of transforming a non-frontal image of an item of clothing into a synthetic frontal image of the item of clothing into a format for use in a VTON space. In some embodiments, method 500 can use a pose transfer neural network pipeline (“pipeline”). Method 500 can be employed in many different embodiments and/or examples not specifically depicted or described herein. In some embodiments, the procedures, the processes, and/or the activities of method 500 can be performed in the order presented or in parallel. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as pose correction system 310 and/or web server 320. The processor(s) can be similar or identical to the processor(s) described above with respect to computer system 100 (FIG. 1).

Turning to FIG. 5, image 510 is a reference image showing a non-frontal pose of an item of clothing where the model in the image is turned and facing away from the front view of the image can be used as an input into the pipeline. In some embodiments, method 500 can include an activity 520 of transforming, using a generated pose transfer model (e.g., post transfer neural network), the non-frontal pose into a synthetic frontal pose where the cloth has been generated using artificial intelligence to simulate pixels of cloth into the new pose. Diagram 525 is a skeleton diagram of image 510, which can be used as a guide to transform image 510 to a new pose that of a pre-configured frontal pose of the item of clothing modeled in an A-frame pose based on the skeleton diagram image. In many embodiments, activity 520 can output an image 530, which is a re-aligned simulated image of a frontal pose of image 510. In a number of embodiments, image 530 can be stored for use in a product pipeline 535, a virtual environment, and/or another suitable digital space.

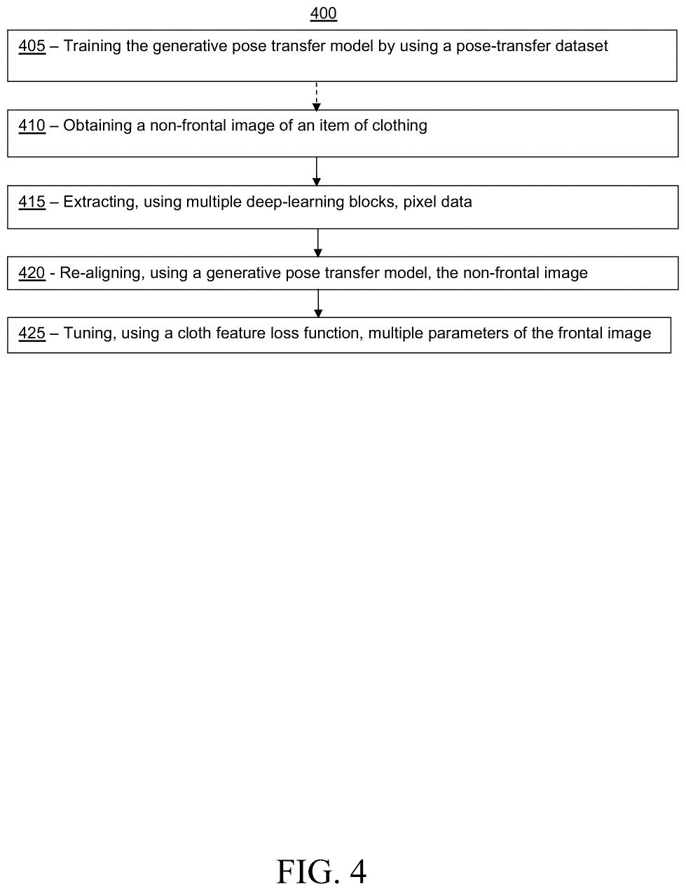

Turning back to the drawings, FIG. 4 illustrates a flow chart for a method 400, according to another embodiment. In some embodiments, method 400 can be a method of automatically transforming a non-frontal image into a frontal image by altering an angle alignment. In many embodiments, transforming a non-frontal image into a frontal image can include tuning multiple parameters of a frontal image. Method 400 is merely exemplary and is not limited to the embodiments presented herein. Method 400 can be employed in many different embodiments and/or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as pose correction system 310 and/or web server 320. The processor(s) can be similar or identical to the processor(s) described above with respect to computer system 100 (FIG. 1).

Referring to FIG. 4, method 400 can, optionally and alternatively, include an activity 405 of training a generative pose transfer model by using a pose-transfer dataset. In various embodiments, training the generative pose transfer model can including training the generative pose transfer model to learn a transformation process that transforms a non-frontal image of a product to a frontal pose image of the same product using generative AI technology. In some embodiments, the pose-transfer dataset can be used for training the neural networks. In several embodiments, the architecture of the pose transfer neural network can be based on at least diffusion neural networks, generative-adversarial network, and/or another suitable generative architecture. In various embodiments, the network architecture can be based on latent or pixel spaces. In some embodiments, the pose transfer neural network can utilize auxiliary inputs such as: a segmentation image of the cloth types indicating a pixel relevance, key points descriptions of the non-frontal image, and/or another suitable image. As an example, in such cases, the architecture can include a dedicated decoder and/or a general processing block per input.

In several embodiments, the pose-transfer dataset can include pairs of images of a human modeling clothing in non-frontal poses and in frontal poses. In some embodiments, activity 405 further can include constructing or generating the pose-transfer dataset with the pairs of images (e.g., paired instances) for the same cloth matched with different poses obtained from a catalog and/or another suitable source. In various embodiments, the pose-transfer dataset can output respective parameters for use by the generative pose transfer model. In some embodiments, the training dataset can be updated periodically by using a feedback loop. In several embodiments, data from the feedback loop can include updating the training dataset so that generative pose transfer model continually learns from the feedback loop so that the generative pose transfer model outputs data with increased accuracy.

In some embodiments, activity 405 of training the generative pose transfer model also can include re-training the generative pose transfer model by calculating an L1/L2/Cosine distance and/or another suitable distance between numerical representations of the source and generated images for use in the cloth feature loss function for back-propagation of each generated synthetic image. In several embodiments, during the re-training process, adding the cloth feature loss function allows this framework to retain or keep key cloth features of the item of clothing. In some embodiments, the difference from the L1 distance can be used as a loss for the back-propagation of the generative pose transfer model. In many embodiments, the generative pose transfer model can use this information to re-train itself to generate similar cloth descriptors between the ground truth image (e.g., original image) and the generated synthetic cloth image.

In various embodiments, method 400 also can include an activity 410 of obtaining a non-frontal image of an item of clothing from a catalog as a candidate for being transformed into a frontal image. In many embodiments, the non-frontal image can be a ghost cloth image (e.g., an image of a cloth without a human model), a flat cloth image, an image of a cloth on a mannequin, and/or another suitable non-frontal image. In several embodiments, automatically deploying the generative pose transfer model (e.g., a pose transfer neural network) can be triggered when a supplier or vendor uploads a non-frontal image of an item of clothing for a catalog that is supplied by the supplier or vendor. Conventionally, approximately 50% or more of items of clothing uploaded by suppliers to a digital site or a catalog (e.g., an online catalog) are non-processable for use in a virtual try-on space (VTON), an augmented reality (AR) environment, and/or another suitable digital environment. In some embodiments, VTON and AR environments can input or utilize frontal images to view the item of clothing. In some embodiments, activity 410 can be similar or identical to the activities use to obtain image 510 (FIG. 5), as described above.

In many embodiments, using the generative pose transfer model with the addition of a cloth feature loss function can be advantageous as the overall framework can transform the non-frontal image into a frontal image while also retaining the item features including cloth, textures, and/or another suitable detail of the non-frontal image which is a technological improvement over the conventional method.

In some embodiments, the trained model can be used to generate an equivalent image or simulated image of the item of clothing and/or another suitable product in a frontal pose. As an advantage, the transformed frontal image of the item of clothing can be substituted for the non-frontal image, uploaded by the supplier, for use in a VTON space, an AR environment, and/or another suitable digital environment.

In some embodiments, method 400 further can include an activity 415 of extracting, using multiple deep-learning blocks, pixel data of a cloth point of interest of the non-frontal image.

In several embodiments, activity 415 of extracting the pixel data also can include segmenting each pixel of the cloth point of interest into multiple clothing types comprising rigid parts, inner parts, and transparent parts.

In various embodiments, method 400 further can include an activity 420 of re-aligning, using a generative pose transfer model, the non-frontal image by altering an angle alignment of a non-frontal pose and filling in missing areas with simulated cloth matching the cloth point of interest into the frontal image. In some embodiments, conventional approaches for pose transfer can include Neural Texture Extraction and Distribution (NTED) used for image synthesis to translate images into a new pose. Conventionally, NTED approaches were unable to fully preserve exact garment or clothing features in the image. For example, during conventional pose transfer approaches, extracting features of an image of a shirt with a polo collar can transform the image of the shirt without the polo collar but instead viewed with a regular collar not representative of the original image. In some embodiments, adding a cloth feature loss function to the training procedures provides an improvement over the conventional technology by improving cloth feature perseverance and preservation of the original image.

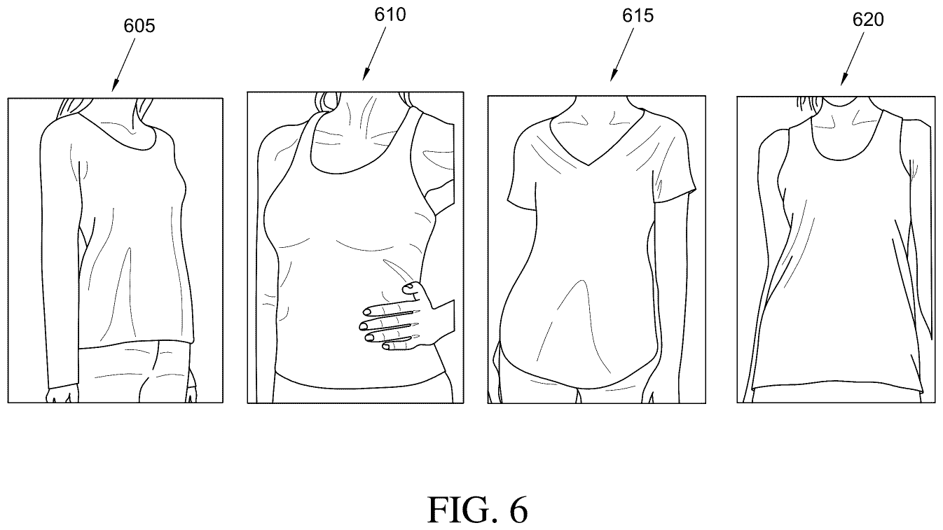

In several embodiments, activity 420 can include identifying whether each of the images of an item uploaded into a digital site or a catalog includes one or more types of image errors. In some embodiments, a predetermined list of image errors can include images with no image file, an angle error, an unknown image, a flat image, a hiding image, a photoshopped image, and/or another suitable image errors. In various embodiments, activity 420 further can include determining which images from among the images designated with an error status can be candidates for re-alignment and generating simulated cloth of the item. In many embodiments, determining candidate images can be based on whether image error in the non-frontal image exceeds a predetermined degree of angle or a predetermined percentage of obstruction of the item viewed in the original image. In various embodiments, images identified with an angle error can include images with non-frontal poses, images that are posed other than in an A-frame pose, images where a body part or another image occludes the view of the item of clothing being modeled by a human model. In some embodiments, FIG. 6 illustrates examples of stock images uploaded by a vendor where all the images are identified as having one or more image errors. In the examples shown in FIG. 6, image 605 is an image identified with angle error where the item of clothing and the model are posed in a non-frontal pose. Image 610 is another example of an image identified with an angle error and a hiding image error where the item of clothing is posed in a non-frontal image and a hand is placed on a portion of the item of clothing occluding the view of the image in that area. Images 615 and 620 are other examples of images of non-frontal poses identified with another type of angle error where the model and the item of clothing are not shown in an A-frame position.

In some embodiments, the generative pose transfer model is trained to generate images of the simulated cloth based on the pixel data and metadata of the item of clothing featured in the non-frontal image.

In a number of embodiments, the generative pose transfer model is also trained to convert an original cloth image of the item of clothing and each synthetic cloth image of the item of clothing into vectors. In several embodiments, creating the vectors can be used to generate the synthetic cloth. In some embodiments, the vectors can be used as a numerical representation of the original and the synthetic cloths to calculate a numerical measure (e.g., measurement) that describes the similarity between them. In several embodiments, such a measure further can be used as an objective measure for minimization improving the ability of the pose transfer network to preserve the cloth details while generating a frontal image.

In various embodiments, activity 420 of re-aligning the non-frontal image also can include generating a synthetic image of a reference image. In some embodiments, generating the synthetic image can include a product of the non-frontal image with the addition of preprocessing artifacts from the non-frontal image, such as key-points, a segmentation map, a text description, and/or another suitable preprocessing artifact. In various embodiments, such inputs can be inserted into the pose transfer network that can produce a frontal image that can be viable for VTON purposes while keeping the cloth details intact.

In several embodiments, activity 420 of re-aligning the non-frontal image further can include transforming the synthetic image into an A-frame image using a multi-loss GAN with attention layers. In many embodiments, alternatively or optionally, re-aligning the non-frontal image can include using a diffusion-based process. In some embodiments, the A-frame image can include a pre-configured frontal pose. In several embodiments, generating an A-frame can be enabled by the pose transfer network and used with a target key-point distribution matching the A-frame pose. In many embodiments, activity 420 can be similar or identical to the transformed image 530 (FIG. 5), as described above.

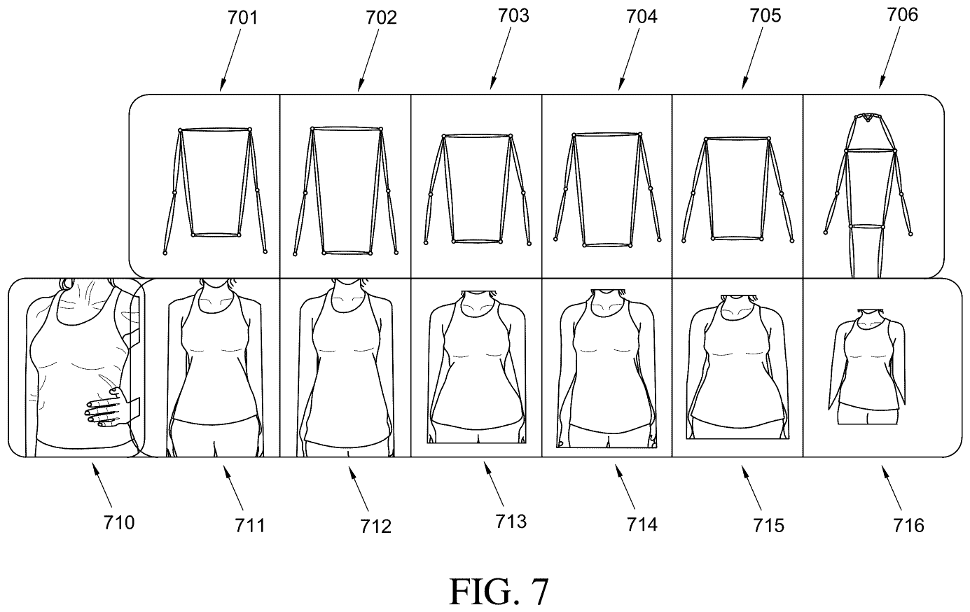

In various embodiments, the pre-configured frontal pose can include a skeleton diagram of the reference image. FIG. 7 illustrates examples of using a skeleton diagram for a reference image of a non-frontal image. Image 710 is a reference image of a non-frontal image and diagrams 701-706 are examples of the multiple skeleton diagrams of multiple A-frame images that can be used to re-aligned the non-frontal images into multiple different visual images of pre-configured frontal poses. Images 711-716 are based on diagrams that correspond to diagrams 701-706. Images 711-716 can show various examples of synthetic images generated by the generative pose model where the synthetic images illustrate re-aligned frontal poses aligned with each pre-configured frontal pose.

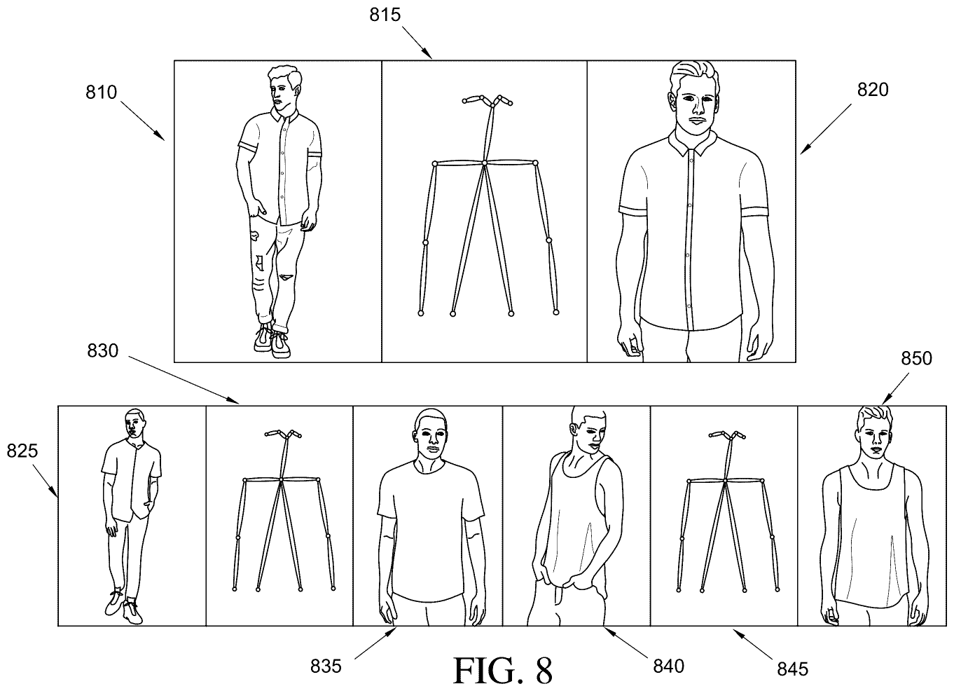

Additionally, FIG. 8 illustrates examples of a non-frontal image transformed into a generated frontal image based on a targeted skeleton pose based on multiple types of angle errors. Image 810 illustrates a reference image uploaded as a stock image by a vendor where the image is a non-frontal image of the item of clothing as worn by a human model. Diagram 815 is an example of a skeleton diagram used to re-align the non-frontal image to a frontal image where the image is re-aligned into an A-frame image using the multi-loss GAN. Image 820 is an example of the re-aligned non-frontal image into a frontal image for can be processed into a VTON simulation. Similarly, images 825 and 840 are other examples of other reference images of non-frontal images uploaded by vendors. Diagrams 830 and 845 are other examples of skeleton diagrams used to re-align each respective reference image into images 835 and 850 that show various examples of synthetic images generated by the generative pose model.

In a number of embodiments, re-aligning the non-frontal image further can include using vision processing to align angles of the non-frontal pose into multiple altered frontal poses. In some embodiments, vision processing can include identifying visual patterns of an item then storing the visual patterns in a visual memory database. In several embodiments, vision processing also can include synthesizing the visual patterns of an item using visual imagery and the visual memory.

In several embodiments, method 400 can include an activity 425 of tuning, using a cloth feature loss function, multiple parameters of the frontal image for a final version of the frontal image. In various embodiments, training the cloth feature loss function can include training a simple framework for contrastive learning of visual representations (e.g., SimCLR) model on a generative pose-transfer dataset.

In some embodiments, the off-line parameters of the generative pose-transfer dataset can be low to describe high-level features between products. For example, a value of 0.075 can be suitable. In several embodiments, generating the value metric can depend on the cloth features that can vary depending on the data set at hand. In some embodiments, a calibrated value can be found in the means of optimization techniques or approaches, such as a grid-search, a Network-Architecture-Search (NAS), and/or another suitable means of optimization techniques.

In several embodiments, training the SimCLR can include training data of pairs of different poses of a same cloth in an image. An advantage of using pairs in the training data can include reducing bias to pose information as the learned descriptor is agnostic to the pose information. In some embodiments, the selected backbone of the pairs can be slim so the memory footprint during training is unaffected by the batch size. As an example, the selected backbone can include edgenet xx small which is of a total size of ˜10-15 MB. In several embodiments, using such a backbone with efficient pair training can yield a network with a slim memory footprint matching the training conditions of a pose transfer network. In many embodiments, the descriptor size can be smaller so the high dimensional distance can be used. In some embodiments, a relatively small value can matche the slim selected backbone in accordance with the required small memory footprint. Such an example can include a value of 168.

In various embodiments, generative pose-transfer network training can proceed once the SimCLR is converged. In some embodiments, the SimCLR model, as trained, can convert both the ground truth image and the generated synthetic image into vectors.

In some embodiments, the cloth feature loss function can implement contrastive loss learning of visual representations by maximizing alternative augmentations of the cloth point of interest.

In various embodiments, the cloth feature loss function can implement contrastive loss learning of visual representations by minimizing a distance between images of the item of clothing.

In several embodiments, activity 425 of tuning the multiple parameters also can include translating, using a pose transfer network, a reference cloth feature of the non-frontal image into a numerical descriptor to measure cloth features of the final version of the frontal image. In some embodiments, a low loss score can indicate that both the generated synthetic image of the cloth and the ground truth image of the cloth has similar features. Such similar features can include collar type, cloth texture, sleeve length, and/or another suitable cloth feature. In many embodiments, each loss can be weighted among existing losses. In some embodiments, the cloth can be translated into numerical descriptor by passing the cloth image through the representation pose transfer neural network (“NN”) which can translate the image into a representative numerical vector that encodes all the fine features that are required for perseverance. In various embodiments, a currently generated image can pass in the same NN to yield the current generated image representation. In several embodiments, the numerical distance between them corresponds to missing information that the generated image is missing where this signal is used as a loss to guide the pose-transfer NN during the training procedure.

In some embodiments, the numerical descriptor of the final version of the frontal image can be within a predetermined numerical domain threshold.

Returning to FIG. 3, communication system 311 can at least partially perform activity 410 of obtaining a non-frontal image of an item of clothing from a catalog as a candidate for being transformed into a frontal image.

In many embodiments, extracting system 312 can at least partially perform activity 415 of extracting, using multiple deep-learning blocks, pixel data of a cloth point of interest of the non-frontal image.

In some embodiments, machine learning system 313 can at least partially perform activity 405 of training the generative pose transfer model by using a pose-transfer dataset; and/or activity 405 of re-training the generative pose transfer model by calculating an L1/L2 cosine distance between numerical representations of a source and images, as generated, for use in the cloth feature loss function for back-propagation of each generated synthetic image.

In several embodiments, aligning system 314 can at least partially perform an activity 420 of re-aligning, using a generative pose transfer model, the non-frontal image by altering an angle alignment of a non-frontal pose and filling in missing areas with simulated cloth matching the cloth point of interest into the frontal image; and/or activity 420 of re-aligning the non-frontal image further can include transforming the synthetic image into an A-frame image using a multi-loss GAN with attention layers.

In a number of embodiments, generating system 315 can at least partially perform activity 425 of tuning the multiple parameters also can include translating, using a pose transfer network, a reference cloth feature of the non-frontal image into a numerical descriptor to measure cloth features of the final version of the frontal image; and/or activity 520 can include transforming, using a generated pose transfer model (e.g., post transfer neural network), the non-frontal pose into a synthetic frontal pose where the cloth has been generated using artificial intelligence to simulate pixels of cloth into the new pose.

In various embodiments, tuning system 316 can at least partially perform activity 425 of tuning, using a cloth feature loss function, multiple parameters of the frontal image for a final version of the frontal image.

In several embodiments, web server 320 can include a webpage system 321. Webpage system 321 can at least partially perform sending instructions to user computers (e.g., 350-351 (FIG. 3)) based on information received from communication system 311.

In many embodiments, the techniques described herein can be used continuously at a scale that cannot be handled using manual techniques. For example, the number of daily and/or monthly visits to the content source can exceed approximately ten million and/or other suitable numbers, the number of registered users to the content source can exceed approximately one million and/or other suitable numbers, and/or the number of products and/or items sold on the website can exceed approximately ten million (10,000,000) approximately each day.

In a number of embodiments, the techniques described herein can solve a technical problem that arises only within the realm of computer networks, as transforming a non-frontal stock image into a frontal image with simulated cloth of the original image, does not exist outside the realm of computer networks. Moreover, the techniques described herein can solve a technical problem that cannot be solved outside the context of computer networks. Specifically, the techniques described herein cannot be used outside the context of computer networks, in view of a lack of data, and because a content catalog, such as an online catalog, that can power and/or feed an online website that is part of the techniques described herein would not exist.

Various embodiments can include a system including one or more processors and one or more non-transitory computer-readable media storing computing instructions, that when executed on the one or more processors, cause the one or more processors to perform certain acts. The acts can include obtaining a non-frontal image of an item of clothing from a catalog as a candidate for being transformed into a frontal image. The acts also can include extracting, using multiple deep-learning blocks, pixel data of a cloth point of interest of the non-frontal image. The acts further can include re-aligning, using a generative pose transfer model, the non-frontal image by altering an angle alignment of a non-frontal pose and filling in missing areas with simulated cloth matching the cloth point of interest into the frontal image. The acts additionally can include tuning, using a cloth feature loss function, multiple parameters of the frontal image for a final version of the frontal image.

A number of embodiments can include a method being implemented via execution of computing instructions configured to run at one or more processors and stored at one or more non-transitory computer-readable media. The method can include obtaining a non-frontal image of an item of clothing from a catalog as a candidate for being transformed into a frontal image. The method also can include extracting, using multiple deep-learning blocks, pixel data of a cloth point of interest of the non-frontal image. The method further can include re-aligning, using a generative pose transfer model, the non-frontal image by altering an angle alignment of a non-frontal pose and filling in missing areas with simulated cloth matching the cloth point of interest into the frontal image. The method additionally can include tuning, using a cloth feature loss function, multiple parameters of the frontal image for a final version of the frontal image.

Although automatically transforming a non-frontal image into a frontal image that can be viewed within a digital environment has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the procedures, processes, or activities of FIGS. 4-5 may include different procedures, processes, and/or activities and be performed by many different modules, in many different orders, and/or one or more of the procedures, processes, or activities of FIGS. 4-5 may include one or more of the procedures, processes, or activities of another different one of FIGS. 4-5. As another example, communication system 311, extracting system 312, machine learning system 313, aligning system 314, generating system 315, and/or webserver 320 (see FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable medium storing computing instructions, that when executed on the processor, cause the processor to perform operations comprising:
obtaining a non-frontal image of an item of clothing from a catalog as a candidate for being transformed into a frontal image;
extracting, using multiple deep-learning blocks, pixel data of a cloth point of interest of the non-frontal image;
re-aligning, using a generative pose transfer model, the non-frontal image by altering an angle alignment of a non-frontal pose and filling in missing areas with simulated cloth matching the cloth point of interest into the frontal image; and
tuning, using a cloth feature loss function, multiple parameters of the frontal image for a final version of the frontal image.

2. The system of claim 1, wherein the computing instructions, when executed on the processor, further cause the processor to perform an operation comprising:
training the generative pose transfer model by using a pose-transfer dataset, wherein the pose-transfer dataset comprises pairs of images of a human modeling clothing in non-frontal poses and in frontal poses.

3. The system of claim 2, wherein training the generative pose transfer model further comprises:
re-training the generative pose transfer model by calculating an L1/L2 cosine distance between numerical representations of a source and generated images for use in the cloth feature loss function for back-propagation of each generated synthetic image.

4. The system of claim 1, wherein extracting the pixel data further comprises:
segmenting each pixel of the cloth point of interest into multiple clothing types comprising rigid parts, inner parts, and transparent parts.

5. The system of claim 1, wherein:
the generative pose transfer model is trained to generate images of the simulated cloth based on the pixel data and metadata of the item of clothing featured in the non-frontal image; and
the non-frontal image is one of a ghost cloth image, a flat cloth image, or an image of a cloth on a mannequin.

6. The system of claim 1, wherein the generative pose transfer model is trained to convert an original cloth image of the item of clothing and each synthetic cloth image of the item of clothing into vectors.

7. The system of claim 1, wherein re-aligning the non-frontal image comprises:
generating a synthetic image of a reference image; and
transforming the synthetic image into an A-frame image, wherein the A-frame image comprises a pre-configured frontal pose, and wherein the pre-configured frontal pose comprises a skeleton diagram of the reference image.

8. The system of claim 1, wherein re-aligning the non-frontal image comprises:
using vision processing to align angles of the non-frontal pose into multiple altered frontal poses.

9. The system of claim 1, wherein the cloth feature loss function implements contrastive loss learning of visual representations by:
maximizing alternative augmentations of the cloth point of interest; and
minimizing a distance between images of the item of clothing.

10. The system of claim 1, wherein tuning the multiple parameters further comprises:
translating, using a pose transfer network, a reference cloth feature of the non-frontal image into a numerical descriptor to measure cloth features of the final version of the frontal image, wherein the numerical descriptor of the final version of the frontal image is within a predetermined numerical domain threshold.

11. A method implemented via execution of computing instructions configured to run on a processor and be stored at a non-transitory computer-readable medium, the method comprising:
obtaining a non-frontal image of an item of clothing from a catalog as a candidate for being transformed into a frontal image;
extracting, using multiple deep-learning blocks, pixel data of a cloth point of interest of the non-frontal image;
re-aligning, using a generative pose transfer model, the non-frontal image by altering an angle alignment of a non-frontal pose and filling in missing areas with simulated cloth matching the cloth point of interest into the frontal image; and
tuning, using a cloth feature loss function, multiple parameters of the frontal image for a final version of the frontal image.

12. The method of claim 11, further comprising:
training the generative pose transfer model by using a pose-transfer dataset, wherein the pose-transfer dataset comprises pairs of images of a human modeling clothing in non-frontal poses and in frontal poses.

13. The method of claim 12, wherein training the generative pose transfer model further comprises:
re-training the generative pose transfer model by calculating an L1/L2 cosine distance between numerical representations of a source and generated images for use in the cloth feature loss function for back-propagation of each generated synthetic image.

14. The method of claim 11, wherein extracting the pixel data further comprises:
segmenting each pixel of the cloth point of interest into multiple clothing types comprising rigid parts, inner parts, and transparent parts.

15. The method of claim 11, wherein:
the generative pose transfer model is trained to generate images of the simulated cloth based on the pixel data and metadata of the item of clothing featured in the non-frontal image; and
the non-frontal image is one of a ghost cloth image, a flat cloth image, or an image of a cloth on a mannequin.

16. The method of claim 11, wherein the generative pose transfer model is trained to convert an original cloth image of the item of clothing and each synthetic cloth image of the item of clothing into vectors.

17. The method of claim 11, wherein re-aligning the non-frontal image comprises at least one of:
(a)
generating a synthetic image of a reference image; and
transforming the synthetic image into an A-frame image, wherein the A-frame image comprises a pre-configured frontal pose, and wherein the pre-configured frontal pose comprises a skeleton diagram of the reference image; or
(b)
using vision processing to align angles of the non-frontal pose into multiple altered frontal poses.

18. The method of claim 11, wherein at least one of:
the cloth feature loss function implements contrastive loss learning of visual representations by:
maximizing alternative augmentations of the cloth point of interest; and
minimizing a distance between images of the item of clothing; or
tuning the multiple parameters further comprises:
translating, using a pose transfer network, a reference cloth feature of the non-frontal image into a numerical descriptor to measure cloth features of the final version of the frontal image, wherein the numerical descriptor of the final version of the frontal image is within a predetermined numerical domain threshold.

19. A non-transitory computer readable storage medium storing computing instructions that, when run on a processor, cause the processor to perform operations comprising:
obtaining a non-frontal image of an item of clothing from a catalog as a candidate for being transformed into a frontal image;
extracting, using multiple deep-learning blocks, pixel data of a cloth point of interest of the non-frontal image;
re-aligning, using a generative pose transfer model, the non-frontal image by altering an angle alignment of a non-frontal pose and filling in missing areas with simulated cloth matching the cloth point of interest into the frontal image; and
tuning, using a cloth feature loss function, multiple parameters of the frontal image for a final version of the frontal image.

20. The non-transitory computer readable storage medium of claim 19, wherein re-aligning the non-frontal image comprises:
generating a synthetic image of a reference image; and
transforming the synthetic image into an A-frame image, wherein the A-frame image comprises a pre-configured frontal pose, and wherein the pre-configured frontal pose comprises a skeleton diagram of the reference image.
